(19) United States
(12) Patent Application Publication
(10) Pub. No.: US 2019/0072383 A1
(43) Pub. Date: Mar. 7, 2019

(54) Imaging LIDAR Altimeter for Operations at Various Ranges and Resolutions

(71) Applicant: Irvine Sensors Corporation, Costa Mesa, CA (US)

(72) Inventors: James Justice, Newport Beach, CA (US); Medhat Azzazy, Laguna Niguel, CA (US); ltzhak Sapir, Irvine, CA (US)

(73) Assignee: Irvine Sensors Corporation, Costa Mesa, CA (US)

(21) Appl. No.: 15/479,775

(22) Filed: Apr. 5, 2017

Related U.S. Application Data
(60) Provisional application No. 62/318,908, filed on Apr. 6, 2016.

(51) Int. Cl. G01C 5/00; G01C 7/02; G01S 17/42; G01S 7/484

(52) U.S. Cl. CPC G01C 5/00; G01S 7/484; G01S 17/42; G01C 7/02

(57) ABSTRACT

An imaging LIDAR that can observe varied size scene areas with varied resolution as range to the observed scene changes and as the need for information to be extracted from the LIDAR sensor data evolves. The LIDAR operates at a fully eye-safe spectral wavelength, operated under all conditions of natural illumination and operate in conditions of clear and degraded visibility. The LIDAR is built of materials that can operate in the radiation environments experienced in space. The disclosed LIDAR sensor system has small size, low weight, and consumes minimal power, thus enabling its deployment on platforms that are constrained by size, weight or power limitations.

### CROSS-REFERENCE TO RELATED APPLICATIONS

This application claims the benefit of U. S. Provisional Patent Application No. 62/318,908, filed on 6 Apr. 2016 entitled “An Imaging LIDAR Altimeter for Operations at Various Ranges and Resolutions” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

### 1. Field of the Invention

The invention relates generally to the field of imaging LIDARs.

More specifically, the invention relates to a LIDAR sensor system that employs technologies in the areas of: 1) high density 3D electronics stacking which enable large area arrays of high speed laser detectors to be integrated with very fast 3D Read Out Integrated Circuits (ROICs), 2) use of selectable holographic lenses to control the LIDAR observed fields of view and to provide uniform illumination over the fields, 3) dynamic range control which enables a single LIDAR sensor system to maintain optimum sensitivity over very large changes in the ranges and required resolutions of diverse operations, and, 4) use of LIDAR operational wavelengths in the SWIR spectral region around 1.5 microns which are fully eye-safe if operated near humans such as during testing, and which do not stimulate or interfere with other VIS/VNIR or thermal instruments in the vicinity of the sensor. Moreover, the SWIR spectral region has robust operational capability in disturbed visual environments that may arise from fog, dust, rain and snow. The LIDAR apparatus of this disclosure can perform very precise measurements of the altitudes and angular slopes of scene elements observed by the LIDAR over highly variable fields of view and with highly variable spatial resolutions.

### 2. Description of the Related Art

Exploratory operations in space, e.g.; lunar and planetary landing, detailed planetary surface observations from space, and operations near and on asteroids and comets all require careful and quantitative mapping of surfaces from extended distances and from close in distances. 3D mapping measurements in which surface distances and the slopes of the surface elements being observed are accurately characterized are needed for high confidence, autonomous operations. There is no integrated, compact measurement instrument available today that can accomplish the highly accurate measurement requirements over the range of observation conditions that may be experienced by such systems. High resolution passive systems do not easily provide range and surface slope measurements. Radars do not provide the high resolutions needed on the short timelines associated with remote proximity and rendezvous operations. Current LIDAR systems can provide the accuracy of measurements required but they, a) do not have the flexibility to successfully operate over the large changes in range, b) do not have sufficient numbers of detectors in their receiver arrays to simultaneously provide the area search rates and resolutions required to support a variety of missions, and, c) do not have the dynamic range controls to support operations over the conditions of observations.

Two general classes of LIDAR systems are available in the market today. One basic type utilizes a scanner which illuminates a very small region of a scene to be mapped at a time and then scans out larger scenes, requiring many laser shots which may have signal pulse energies in the 10s of micro-joules.

This type of laser provides low pulse energy but very high pulse rate which fundamentally limits the ranges at which highly accurate mapping can occur. The best of such systems are limited to altitudes of 5 km or under. The LEIKAALS80 for instance is the state of the art in this type of LIDAR.

The second type of LIDAR is a flash LIDAR where single pulses of high energy, typically 1-3 milli-joules, are used to illuminate scene areas that contain many spatial elements to be mapped. The state of the art in this type of LIDAR is the Advanced Scientific Concepts Goldeneye Flash LIDAR. A fixed lens in any of its configurations is used and fixes the field of illumination size. The performance of this flash LIDAR is generally limited to about 3 Km.

What is needed is a type of LIDAR that has a variable field of illumination that can be adjusted while the LIDAR is conducting a mission where the ranges of operation change over 100 km and the required resolution changes from meters to centimeters at the range of operations varies. Further such LIDARs must be able to operate over very large changes in scene brightness as the ranges and resolutions vary widely. No known state-of-the-art LIDAR can meet these needs. Such a LIDAR is the subject of the apparatus disclosed herein.

### BRIEF SUMMARY OF THE INVENTION

A LIDAR sensor system is disclosed which provides a capability to adjust the area of a scene being illuminated by an eye-safe laser operating in the 1.5 micron wavelength, adjusts the spatial resolution across that scene, and adjusts the temporal sampling of detectors sensitive to the laser light, thus enabling a variety of mission functions to be performed as the LIDAR system operates over a large extent of ranges to the observed scene. Such a LIDAR sensor system, if made of components intended for use in radiation environments experienced in space (sometimes to referred to as “radiation hardened” or “rad-hard” components), can support complex rendezvous and landing missions conducted by autonomous platforms. The choice of laser wavelength enables operation under all conditions of lighting and operations in clear and degraded visibility conditions.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 shows an exemplar design of an imaging LIDAR optimized for altimeter operations over a very large variation of observing range and the key elements of the design concept.

FIG. 2 shows an exemplar concept of operations for the Imaging LIDAR Altimeter and the performance anticipated from exploiting its operational flexibility.

FIG. 3 provides the component parameter specifications of the exemplar Imaging LIDAR Altimeter.

FIG. 4 shows the performance of the Imaging LIDAR Altimeter at various operational points in the Operations Concept described in FIG. 2.

FIG. 5 illustrates state-of-the-art component technologies that enable the Imaging LIDAR Altimeter design and performance realization.

The invention and its various embodiments can now be better understood by turning to the following description of the preferred embodiments which are presented as illustrated examples of the invention in any subsequent claims in any application claiming priority to this application. It is expressly understood that the invention as defined by such claims may be broader than the illustrated embodiments described below.

### DETAILED DESCRIPTION OF THE INVENTION

Turning now to the figures wherein like numerals define like elements among the several views, the Imaging LIDAR Altimeter disclosed herein consists of various elements which, when integrated together, enable the LIDAR sensor system to make highly accurate measurements of range to and the slope of surface elements being observed by the apparatus. The design of the apparatus is a compact, low weight, form requiring low power.

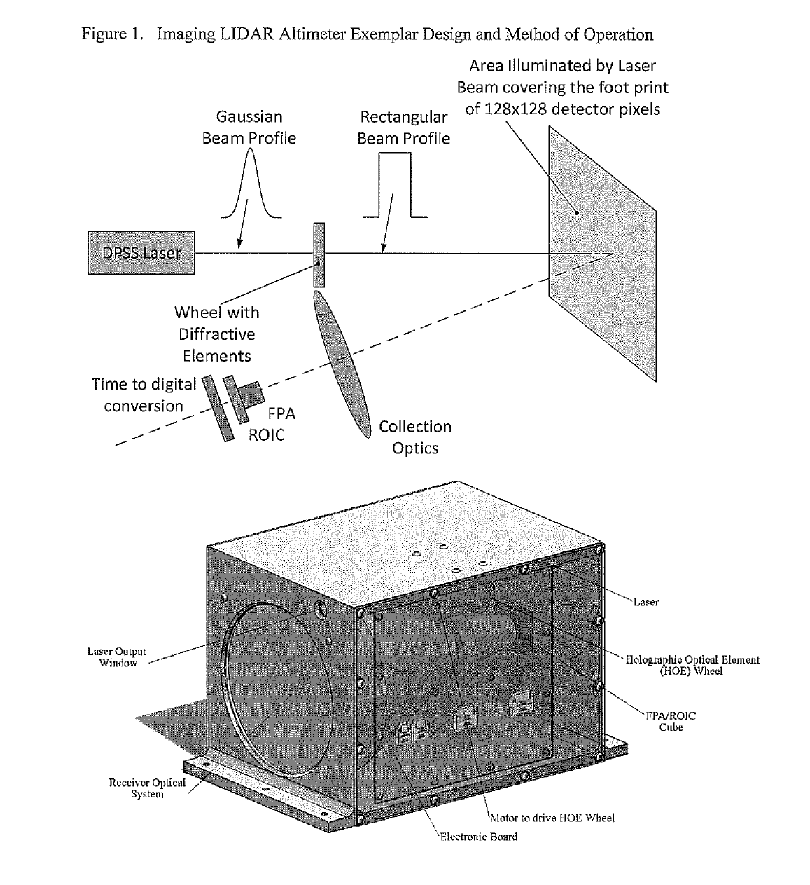

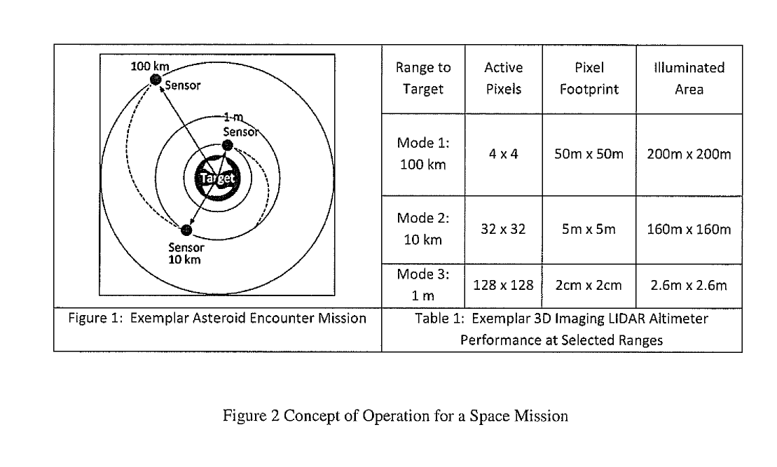

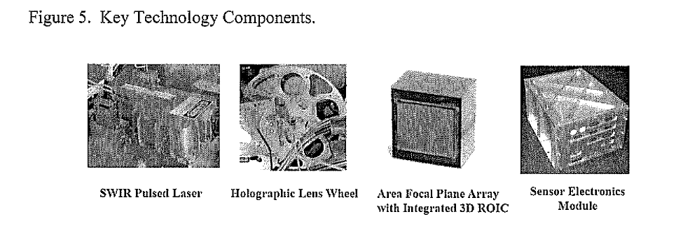

This exemplar design, shown in FIG. 1, may have the following characteristics: size=7.8×7.8×8.7 in.; weight=11 lbs; and power needed for operation=15 watts. Highly accurate range measurements are enabled by use of very fast detectors operating in the SWIR spectral band at 1.5 microns wavelength. The detectors are arranged in an area array format. Each detector is connected to a circuit that provides vary fast sampling of the detector outputs. These circuits are preferably arranged in an integrated, three dimensional stack of electronics chips as illustrated in FIG. 5. A diode-pulsed laser, likewise operating at the 1.5 micron wavelength, illuminates the scene in the area observed by the detector tor array. The size of the scene that is illuminated is determined by an array of holographic lenses that define the outgoing beam shape and size. An optical receiver telescope collects the photons returning from each of the scene elements and focuses them on the area detector array. This receiver telescope has zoom capability to enable its adjustment to mission needs. The fast sampling circuits allow the range to the illuminated scene element to be detrained with high accuracy and the slope of the scene element to be determined with high accuracy. As the operating ranges to the scenes change in typical mission scenarios as illustrated in FIG. 2, the Imaging LIDAR Altimeter adjusts its field of view and resolution to meet mission objectives. An important feature of the Imaging LIDAR Altimeter is the very large dynamic range of the entire detection and processing chain. The mission driven changes in range and resolution can result in orders of magnitude changes in signal brightness which must be accommodated by the detection and processing chain. In order to determine the performance of the Imaging LIDAR Altimeter, key component parameters must be set and then combined in an analysis to predict performance.

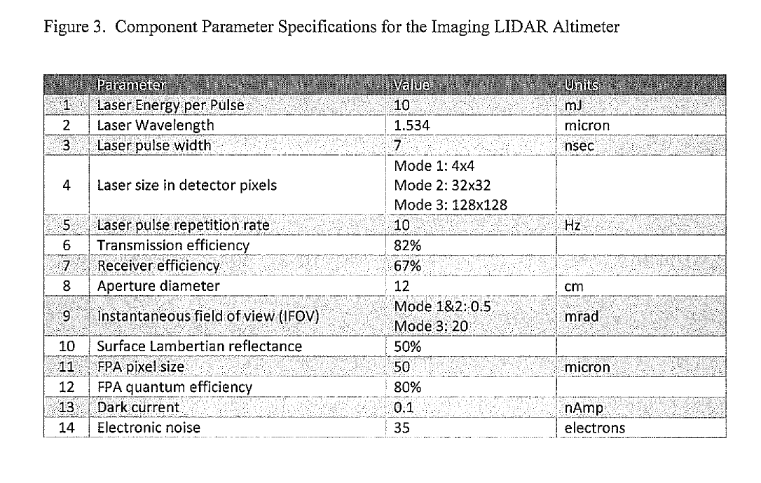

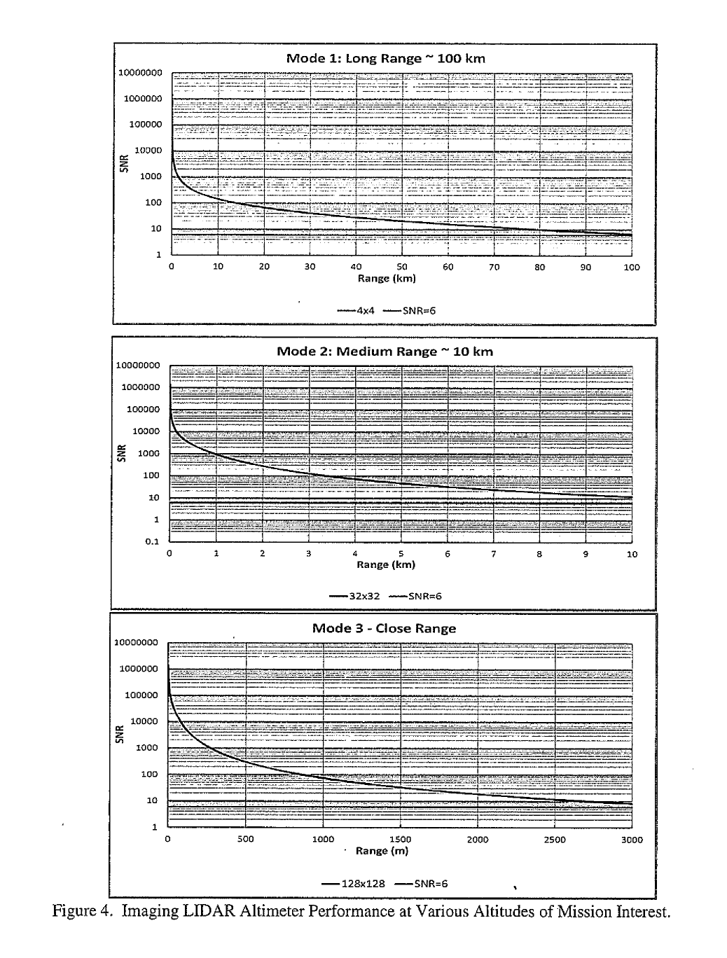

The key parameters of the exemplar Imaging LIDAR Altimeter shown in FIG. 1 are listed in FIG. 3. The operational Imaging LIDAR Altimeter concept illustrated in FIG. 2 is now used to provide selected operating points for analysis. The performance results are provided in FIG. 4.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by any claims in any subsequent application claiming priority to this application.

For example, notwithstanding the fact that the elements of such a claim may be set forth in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a subsequent claim must be understood as being generic to all possible meanings supported by the specification and by the word itself.

The definitions of the words or elements of any claims in any subsequent application claiming priority to this application should be, therefore, defined to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements in such claims below or that a single element may be substituted for two or more elements in such a claim.

Although elements may be described above as acting in certain combinations and even subsequently claimed as such, it is to be expressly understood that one or more elements from a claimed combination can in some cases be excised from the combination and that such claimed combination may be directed to a subcombination or variation of a subcombination.

Insubstantial changes from any subsequently claimed subject matter as viewed by a person with ordinary skill in the art, now known or later devised, are expressly contemplated as being equivalently within the scope of such claims. Therefore, obvious substitutions now or later known to one with ordinary skill in the art are defined to be within the scope of the defined elements.

Any claims in any subsequent application claiming priority to this application are thus to be understood to include what is specifically illustrated and described above, what is conceptually equivalent, what can be obviously substituted and also what essentially incorporates the essential idea of the invention.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A LIDAR Sensor System that performs precise measurements of the altitude and angular slopes of scene elements observed by the LIDAR over highly variable fields of view, over highly variable spatial resolutions, and over highly variable ranges.

2. The LIDAR Sensor System of claim 1 may contain a diode pulsed laser operating in a fully eye-safe spectral region.

3. The LIDAR Sensor System of claim 1 may contain and area array of detectors sensitive to the laser output wavelength.

4. The LIDAR Sensor System of claim 1 may contain an electronic Read-Out Integrated Circuit (ROIC) for each of the detectors in the area array that enables information to be extracted over a very large dynamic range by providing very fast sampling times.

5. The LIDAR Sensor System of claim 1 may contain a three dimensional stack of electronic chips that host all the individual ROICs supporting the detector area array.

6. The LIDAR Sensor System of claim 1 may contain a set of selectable holographic lenses placed in the output laser beam to determine the angular size and the illumination pattern of the exiting beam.

7. The LIDAR Sensor System of claim 1 may contain a telescope for receiving laser returns from the illuminated scenes that has a zoom capability used to adjust the resolution and size of the area being observed in response to the range to the scene and the information needs of the activity being conducted.

8. The LIDAR Sensor System of claim 1 may contain mechanical elements, electrical circuits, and computational elements that enable the transmit and receive optics and the temporal sampling of the detectors to be adjusted in concert to achieve the very large dynamic range of operations of the concept.

9. The LIDAR Sensor System of claim 1 may contain parts selected to enable the System to operate in the radiation environments experienced in space.
